(19) United States
(12) Patent Application Publication
(10) Pub. No.: US 2004/0090164 A1
(43) Pub. Date: May 13, 2004

(54) Color cathode ray tube and tension type mask structure that is assembled within a color cathode ray tube

(76) Inventors: Yusuke Akiyama, Tokyo (JP); Haruo Watanuki, Tokyo (JP); Toshikazu Karita, Tokyo (JP); Keizou Makino, Tokyo (JP); Mizuki Murata, Tokyo (JP); Kazushi Nagasawa, Tokyo (JP)

Correspondence Address: BIRCH STEWART KOLASCH & BIRCH, PO BOX 747, FALLS CHURCH, VA, 22040-0747, US

(21) Appl. No.: 10/622,693

(22) Filed: Jul. 21, 2003

(30) Foreign Application Priority Data
Nov. 7, 2002 (JP) 2002-323710

(51) Int. Cl. H01J 29/80

(52) U.S. Cl. 313/402

(57) ABSTRACT

A tensioned mask structure for a color CRT includes a color-selecting mask that is formed with a plurality of electron beam passing holes therein, a mask frame on which the color-selecting mask is mounted, and a vibration-attenuating mechanism in contact with the color-selecting mask to damp vibration of the color-selecting mask. The color-selecting mask includes an effective mask area having a slit region and a slot region. The slit region has a plurality of long narrow elements that extend in a vertical direction of a screen of the CRT and are aligned to define slit-like holes between adjacent long narrow elements. The slot region has a plurality of slot-like holes shorter than the slit-like holes, the slot-like holes extending in the vertical direction. The slit region is formed in an area except a left peripheral portion and a right peripheral portion of the effective mask area.

### BACKGROUND OF THE INVENTION

1. Field of the Invention

The present invention generally relates to a cathode ray tube (CRT) and more particularly to a tensioned mask structure assembled in a color cathode ray tube.

2. Description of the Related Art

A color CRT for use in a television receiver and a display of a computer has a color-selecting electrode (referred to as a color-selecting mask hereinafter). The color-selecting mask is a thin metal plate selectively etched to form a plurality of beam-passing holes therein. Typically, a color-selecting mask has substantially rectangular beam-passing holes (slot hole). Such a color-selecting mask has bridges (real bridges) that connect holes in a horizontal direction of the screen of the CRT, and is called a real bridge mask.

Another typical configuration of a color-selecting mask is such that a large number of thin wire-like elements are aligned at predetermined intervals without real bridges formed therebetween to define beam-passing holes between adjacent wire-like elements. This configuration is referred to as an aperture grille.

An aperture grille is held so that the thin wire-like elements are taut and damper wires made of a metal are held in contact with the wire-like elements. The damper wires are held to extend in directions substantially perpendicular to directions in which the wire-like elements extend. When an impact is given to the wire-like elements, the wire-like elements are apt to vibrate. The frictional engagement of the damper wires with the thin wire-like elements serves to damp the vibration of the wire-like elements.

With a real bridge mask, a color-selecting mask made by press working is supported and secured on a mask frame while also maintaining the color-selecting mask substantially in its original shape. Due to the difference in construction, a real bridge mask is more rigid than an aperture grille, and lends itself to efficient assembling operation of a CRT.

However, a problem associated with the real bridge mask is Moire. Moire occurs when the scanning lines of electron beam interfere with the real bridges of a color-selecting mask, and is one of the factors that cause image deterioration. A color-selecting mask is disclosed in Japanese Patent Laid-Open No. 2001-84918. This prior art color-selecting mask solves the problem of Moire fringes. Dummy bridges (i.e., air gaps) are provided between adjacent real bridges to form projections not connected to each other.

A recent tendency of a color CRT is a flat face panel and accordingly the color-selecting mask needs to be flat. The flatness of a color-selecting mask cannot be maintained by merely mounting a mask formed by pressing work to a mask frame as in conventional real bridge mask. A real bridge mask is mounted on a mask frame with tension in the same manner as an aperture grille. This type of color-selecting mask is referred to as a tensioned real bridge mask.

As described above, with a color-selecting mask mounted on a mask frame with tension, the mask can vibrate due to shock applied from outside or vibration propagating from a speaker. Therefore, the tension of the color-selecting mask alone is not enough to damp vibrations. The vibration of the color-selecting mask is not desirable because it directly causes the vibration of a displayed image. The duration of vibration should be as short as possible if a vibration occurs.

However, unlike an aperture grille, a tensioned real bridge mask has real bridges that couple all the long narrow elements together over the entire mask area. Thus, when an impact or shock is applied to a part of the color-selecting mask, the vibration due to the impact propagates from one area to other areas of the color-selecting mask. As a result, the entire color selecting mask vibrates. A major portion of such a surface vibration is oriented in the direction of axis of the color CRT. Thus, the damper wires employed in an aperture grille is not effective in damping the vibration in this direction.

Another color-selecting mask is disclosed by Japanese Patent Laid-Open No. 3300669, which solves the aforementioned vibration problem. A vibration attenuator is provided on the peripheral portion of a tensioned real bridge mask, so that the frictional engagement of vibration attenuator with the color-selecting mask attenuates the vibration of the mask. However, this structure is effective in damping vibrations at the peripheral portion of the color-selecting mask very near the vibration attenuator but does not prevent the vibration from propagating. For example, vibration that occurs near the middle of the screen propagates to areas other than the peripheral of the color-selecting mask, and therefore a sufficient vibration-damping effect cannot be obtained.

Still another example is disclosed in Japanese Patent Laid Open No. 2002-42670 in which the number of real bridges of a color-selecting mask becomes smaller nearer the end of the screen, thereby damping the propagation of vibration. Yet another example is disclosed in Japanese Patent Laid Open No. 2002-42675, which discloses a structure in which a color-selecting mask has damper wires.

Japanese patent Laid Open No. H7-230772 discloses an example in which the number of real bridges is smaller at the middle of the screen than at the peripheral portion of the screen, thereby absorbing thermal expansion of a color-selecting mask.

For the examples disclosed in Japanese Patents Laid Open No. 2002-42670 and No. 2002-42675, the real bridges exist over the entire area from the middle of the color-selecting mask to the peripheral portions. Thus, there is no essential difference between these color-selecting masks and conventional tensioned real bridge masks. The color-selecting masks of Japanese Patents Laid Open No. 2002-42670 and No. 2002-42675 are unable to prevent vibration from propagating in the areas from the middle of the color-selecting mask and its peripheral portions.

Portions having no or a very small number of real bridges in these real bridge masks behave like an aperture grille. Thus, the damper wires are able to damp the vibration in the areas, but are not able to prevent the vibration from propagating.

In contrast, an aperture grille has the disadvantage that narrow slits in the vicinity of the peripheral portions are apt to deform. This disadvantage creates difficulties in the design of a mask and the manufacture of a color CRT.

A tensioned real bridge mask has desirable properties, I.e., the real bridges enhance the rigidity of the mask near the peripheral portions and the color-selecting mask is not likely to deform. If a tensioned real bridge mask has a mask structure in which the number of real bridges of the color-selecting mask decreases nearer the peripheral portions, the peripheral portions of the mask are more like an aperture grille. As a result, such a structure impairs the desirable properties of a tensioned real bridge mask.

With the structure disclosed in Japanese Patent Laid Open No. H7-230772, areas having less real bridges operate more like an aperture grille and therefore vibration is apt to occur in the horizontal direction of the screen. The color-selecting mask according to Japanese Patent Laid Open No. H7-230772 has an area in which no real bridge is present. Therefore, such an area is very sensitive to vibration exerted from outside and continues to vibrate for a long time after a shock is given to the mask.

### SUMMARY OF THE INVENTION

An object of the invention is to provide a tensioned mask structure having excellent characteristics of damping vibration and increasing the rigidity of the peripheral portions of the mask.

A tensioned mask structure for a color CRT includes a color-selecting mask that is formed with a plurality of electron beam passing holes therein, a mask frame on which the color-selecting mask is mounted, and a vibration-attenuating mechanism in contact with the color-selecting mask to damp vibration of the color-selecting mask. The color-selecting mask has an effective mask area that includes a slit region and a slot region. The slit region has a plurality of long narrow elements that extend in a vertical direction of a screen of the CRT and are aligned to define slit-like holes between adjacent long narrow elements. The slot region has a plurality of slot-like holes shorter than the slit-like holes, the slot-like holes extending in the vertical direction. The slit region is formed in an area except a left peripheral portion and a right peripheral portion of the effective mask area.

The slit-like holes are defined by forming bridges that connect adjacent long narrow elements at predetermined intervals. The bridges near a boundary between the slit region and the slot region are formed in accordance with a shape of slit region such that a substantially straight boundary is defined between the slit region and the slot region.

The slit-like holes are defined by forming bridges that connect adjacent long narrow elements at predetermined intervals. The bridges near a boundary between the slit region and the slot region are formed in accordance with a shape of the slit region to define the boundary such that each of the bridges is displaced ahead of a preceding one in the vertical direction of the screen.

The slit region is symmetrical with respect to a horizontal center line of the effective mask area and with respect to a vertical center line of the effective area.

The vibration-attenuating mechanism includes at least two springs and at least one damper wire. The at least two springs are provided on the mask frame. The at least one damper wire is mounted in contact with the color-selecting mask between the two springs so that the damper wire is held taut across the effective mask area.

The slit region has a horizontal length in the range of 5 to 95% of a full horizontal length of the effective mask area.

The slit region has a vertical length in the range of 20 to 100% of a full vertical length of the effective mask area.

The slot-like holes are defined by forming bridges that connect adjacent long narrow elements at predetermined intervals.

Each of the slot-like holes has opposing sides that extend substantially in the vertical direction and a side at an angle with the horizontal direction.

Each of the slot-like holes has a constriction defined by projections that project toward each other from adjacent long narrow elements.

A color CRT has a face panel, a funnel, and a neck which are formed in one piece construction, and incorporates the aforementioned tensioned color-selecting mask.

A tensioned mask structure for a color CRT includes a color selecting mask formed with a plurality of electron beam passing holes, a mask frame on which the color-selecting mask is mounted, and a vibration-attenuating mechanism in contact with the color-selecting mask to damp vibration of the color-selecting mask. The color-selecting mask includes an effective mask area that includes a slot region having slot-like holes and a mixture region having slit-like holes and slot-like holes. The slit-like holes are defined between adjacent ones of a plurality of long narrow elements that extend in a vertical direction of a screen of the CRT. The slot-like holes are shorter than the slit-like holes and extend in the vertical direction. The mixture region is formed in an area except a left peripheral portion and a right peripheral portion of the effective mask area.

The slit-like holes are defined by forming bridges that connect adjacent long narrow elements at predetermined intervals. The bridges are formed to define a substantially straight boundary between the mixture region and the slot region.

The slit-like holes are defined by forming bridges that connect adjacent long narrow elements at predetermined intervals. The bridges near a boundary between the slit region and the slot region are formed in accordance with a shape of the slit region to define the boundary such that each of the bridges is displaced ahead of a preceding one in the vertical direction of the screen.

The vibration-attenuating mechanism includes at least two springs and at least one damper wire. The at least two springs are provided on the mask frame. The at least one damper wire is mounted in contact with the color-selecting mask between the two springs so that the damper wire is held taut across the effective mask area.

A color CRT has a face panel, a funnel, and a neck which are formed in one piece construction, and incorporates the aforementioned tensioned color-selecting mask.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limiting the present invention, and wherein:

FIGS. 1A-1C illustrate a pertinent portion of a tensioned mask structure for a color CRT according to a first embodiment, FIG. 1A being a perspective view of pertinent portions, and FIGS. 1B and 1C being enlarged views of the pertinent portions;

FIG. 2 illustrates a pertinent of a color CRT having a tensioned mask structure;

FIGS. 3A-3C illustrate the location of the slit region and slot region formed in the color-selecting mask;

FIGS. 4 and 5 illustrate the relations between locations in the horizontal direction and normalized time T required for vibration in the direction of axis of the CRT to decay;

FIGS. 6A and 6B illustrate modifications of the slit region;

FIGS. 7A and 7B illustrate another modifications of the slit region;

FIGS. 7C-7F illustrate modifications to the slit region;

FIGS. 8A and 8B illustrate the arrangement of real bridges formed in a tensioned mask structure for a color CRT according to a second embodiment;

FIGS. 9A and 9B illustrate the arrangement of the real bridges formed in a tensioned mask structure that does not employ the configuration of the second embodiment;

FIGS. 10A and 10B illustrate the slits when the color-selecting mask in FIG. 9A is mounted on the mask frame;

FIGS. 11A and 11B illustrate another modifications of the slit region;

FIGS. 12A-12C illustrate the shape of slots formed in a tensioned mask structure according to a third embodiment for a color CRT of the invention;

FIGS. 13A-13C illustrate a pertinent portion of a tensioned mask structure according to a fourth embodiment of a color CRT;

FIGS. 14A-14C illustrate a pertinent portion of a tensioned mask structure according to a fifth embodiment for a color CRT; and

FIGS. 15A-15C illustrate modifications to the dummy bridges.

### DETAILED DESCRIPTION OF THE INVENTION

### First Embodiment

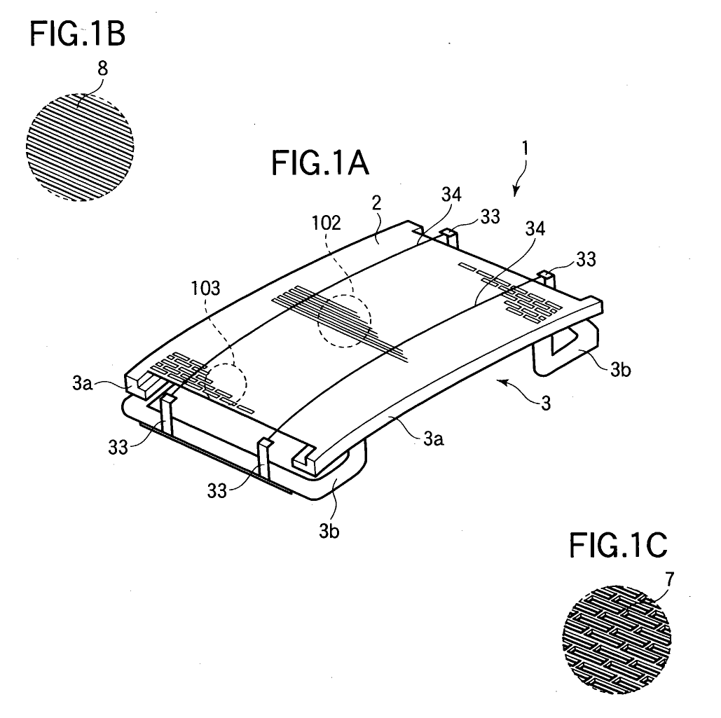

FIGS. 1A-1C illustrate a pertinent portion of a tensioned mask structure for a color CRT according to a first embodiment.

FIG. 1A is a perspective view of pertinent portions of the first embodiment.

FIGS. 1B and 1C are enlarged views of the pertinent portions 102 and 103 of FIG. 1A, respectively.

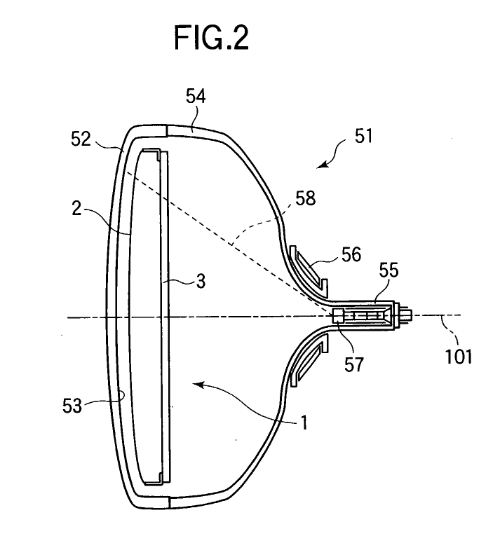

FIG. 2 illustrates a pertinent portion of a color CRT having a tensioned mask structure.

Referring to FIG. 2, a glass bulb forms an outer geometry of a color CRT 51. The glass bulb includes a face panel 52, a funnel 54, and a neck 55, which are continuous with one another. The funnel 54 is formed between the face panel 52 and the neck 55.

An electron gun 57 is provided in the neck 55 and is positioned in line with an axis 101. A color-selecting mask 2, which will be described later, is positioned in proximity to a fluorescent screen 53. A tensioned mask structure 1 is securely positioned in place by means of mounting angles, not shown.

A deflection yoke 56 is used to controllably deflect three electron beams 58 emitted from the electron gun and rides on a portion extending from the funnel 54 to the neck 55. The color-selecting mask 2 is used to select three electron beams 58 so that beams will land on red, green, and blue spots, respectively, formed on the fluorescent screen 53.

The tensioned mask frame 1 that includes the color-selecting mask 2 will be described with reference to FIGS. 1A-1C.

As shown in FIG. 1A, the tensioned mask structure 1 includes the color-selecting mask 2 and a mask frame 3. The mask frame 3 is made of steel 1 and has a pair of H members 3a and a pair of V members 3b. The two opposed long sides of the color-selecting mask 2 are welded to the H members, so that the mask 2 is held taut. The H members are supported across the V members.

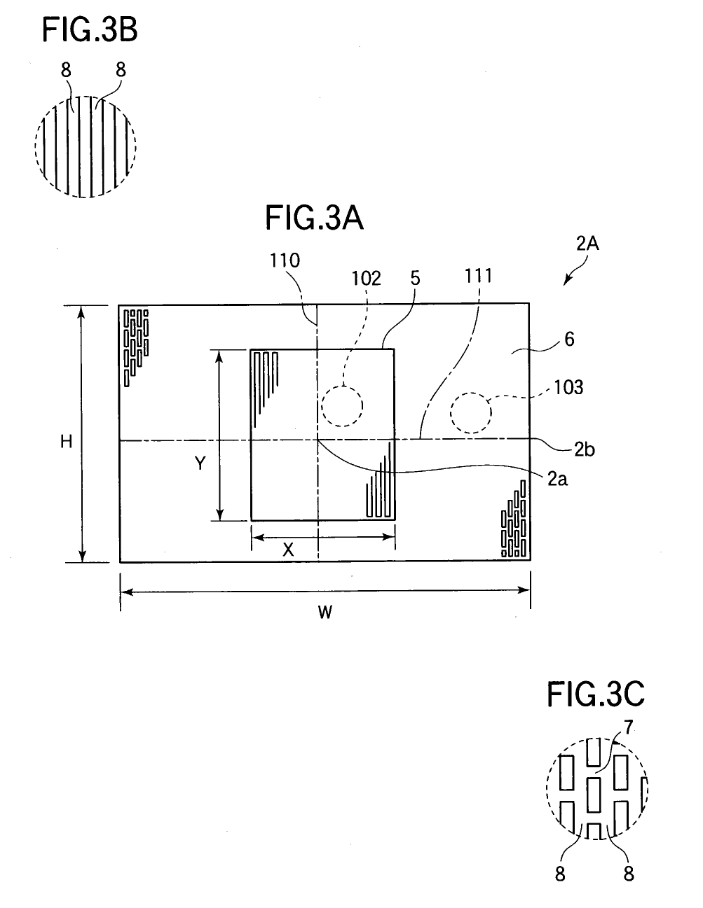

The color-selecting mask 2 has electron beam passing holes formed therein, the shape of the holes being different depending on areas on the color-selecting mask 2. As shown in FIG. 1B, a slit region 5 (see also FIGS. 3B) , which will be described later, is an aperture in which electron beam passing holes are formed by long narrow elements 8 that extend in a direction parallel to short sides of the mask 2 and are aligned in a direction parallel to long sides of the mask 2. The long narrow elements 8 define narrow slits therebetween, the slits extending in the direction in which the long narrow elements 8 extend and being aligned in the direction parallel to long sides of the mask 2.

As shown in FIG. 1C, the slot region 6 (see also FIG. 3C) is of real bridge construction. A plurality of bridges 7 of a predetermined length are formed between adjacent long narrow elements 8, thereby forming a real bridge mask with a line of slot holes. The lines of slot holes are aligned such that the slot holes in each line are staggered with respect to slot holes in an adjacent line.

The slit region 5 extends in an effective mask area of the color-selecting mask except left most end and right most end of the mask through which the electron beams can pass. The slit region 5 is so designed, thereby ensuring that the bridges 7 are formed on the left and right ends of the mask 2 to provide a required rigidity of the mask 2.

Two pairs of damper springs 33 are welded to the pair of the V members 3b of the mask frame 3. A damper wire 34 is held taut between each pair of springs 33. The damper wires 34 are in contact with the long narrow elements 8 so that friction is created between the damper wires 34 and the long narrow elements 8. This friction serves to damp vibration applied to the tensioned mask structure 1.

While the first embodiment has been described with respect to a vibration damping mechanism for an aperture grilles in the form of a damper wire, the present invention is not limited to this configuration. The slits or real bridges can be prevented from vibrating by using other vibration damping mechanism or a combination of these mechanisms.

FIGS. 3A-3C illustrate the location of the slit region 5 and slot region 6 formed in the color-selecting mask. FIG. 3A illustrates the dimension of the color-selecting mask 2. FIGS. 3B and 3C are partial expanded views of FIG. 3A, illustrating portions 102 and 103, respectively. Line 110 is a vertical center line of the mask 2 and line 111 is a horizontal center line. The locations of the slit region 5 and slot region 6 will be described with reference to FIGS. 3A-3C. Referring to FIG. 3A, the effective mask area 2A of the color-selecting mask 2 is substantially rectangular, having short sides H (height of image) and long sides W (width of image). The slit region 5 has a height Y and a width X and is in alignment with the effective mask area 2A. The slit region 5 is symmetrical with respect to the vertical center line 110 as well as the horizontal center line 111.

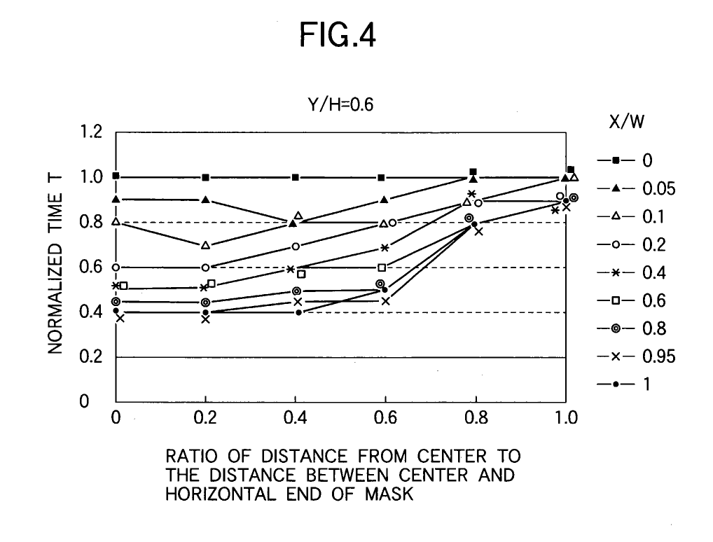

FIGS. 4 and 5 illustrate the relations between locations in the horizontal direction and normalized time T required for vibration in the direction of axis 101 of the CRT to decay.

FIG. 4 illustrates the relation for different values of Y/X when Y/H is 0.6. FIG. 5 illustrates the relation for different values of Y/H when X/W is 0.6.

The location in the horizontal direction is expressed in terms of the ratio of a distance from the center 2a to the distance between the center 2a and the horizontal end 2b. The normalized time T is expressed in terms of the ratio of the time required for a vibration to decay to the time required for the vibration when the slit region 5 is not formed. Thus, when the slit region 5 is not formed, the time required for a vibration to decay is 1.

It is to be noted that the time T generally decreases as the value of X/W increases.

The relations shown in FIGS. 4 and 5 indicate that the effect of damping vibration of the color-selecting mask in the direction of the axis 101 of the CRT increases as the slit region 5 expands from the center of the screen, in which vibration is most serious, toward the peripheral portions of the screen.

As described above, expanding the slit region 5 is more effective in retarding the surface propagation of vibration associated with a tensioned real bridge structure. However, excessively expanding the slit region 5 results in a decrease in rigidity of the structure and problems in handling the structure during manufacture.

The results in FIGS. 4 and 5 show that X/W and Y/H smaller than certain values are not so effective in damping vibration. Vibration-damping effect may not be improved for X/W and Y/H greater than a certain values.

From the standpoints of production efficiency and vibration-damping effect, the desired values of X/W and Y/H of the color-selecting mask 2 are such that 0.05≦X/W≦0.95 and 0.2≦-Y/H≦1. Specific values of X/W and Y/H can be determined taking into account the screen size of a CRT as well as characteristics resulting from other factors.

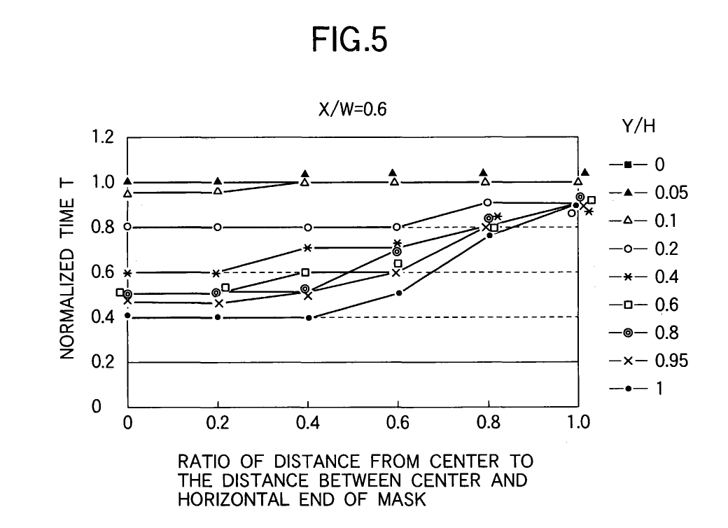

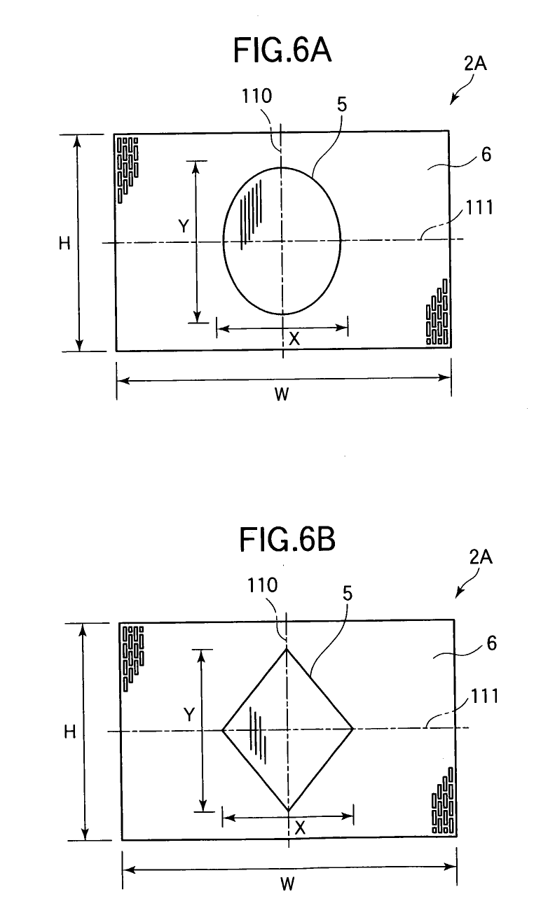

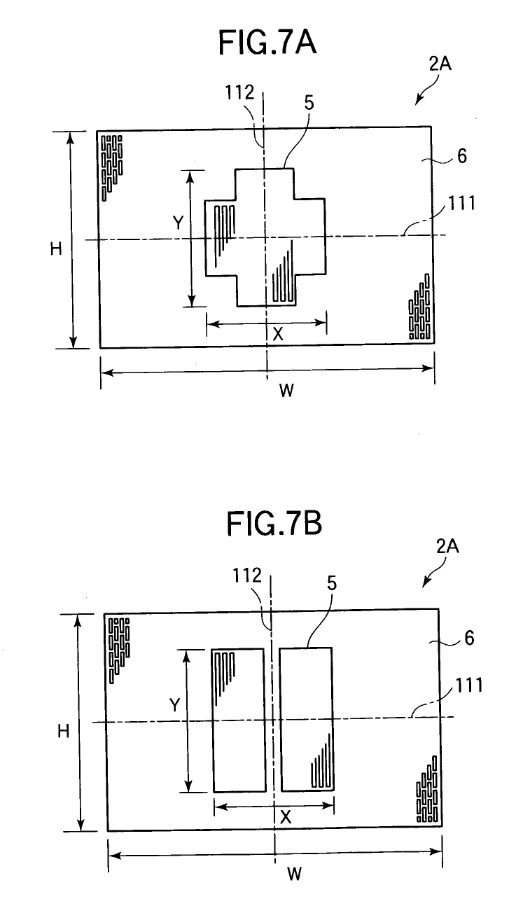

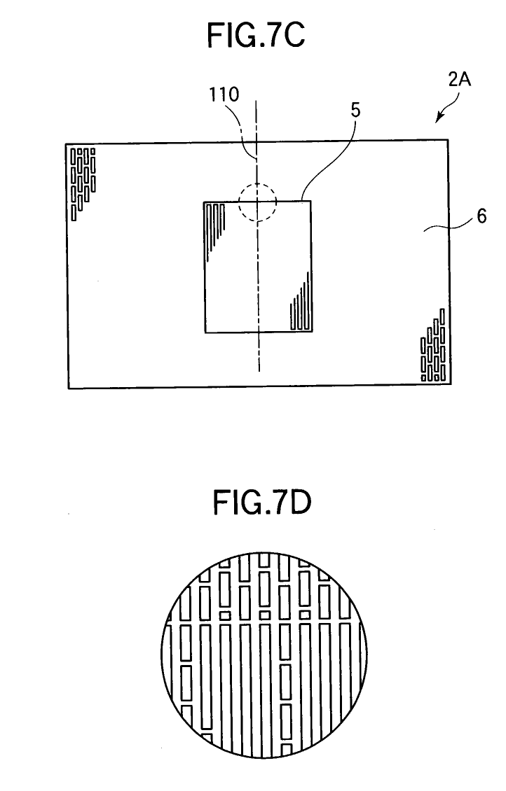

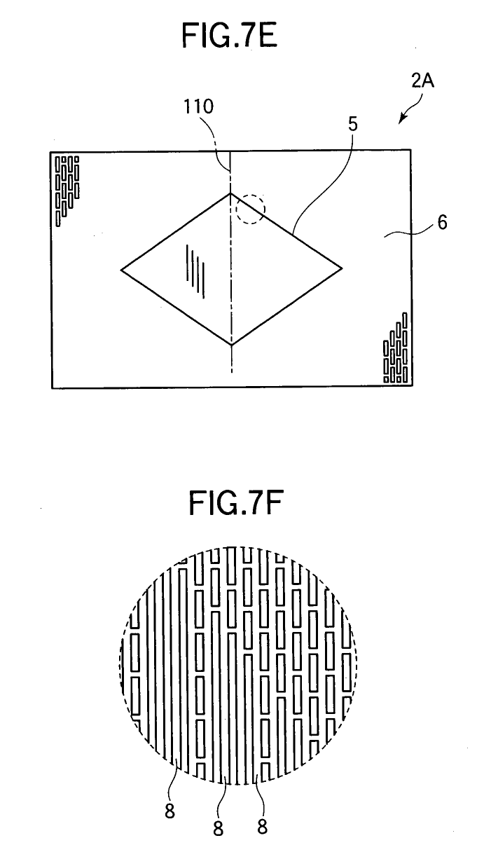

While the slit region 5 in FIG. 3C is substantially rectangular, the shape of the slit region can be of various other shapes, for example, an ellipse in FIG. 6A and a diamond in FIG. 6B. In the present invention a diamond shape includes a square, a special case of a diamond in which all the sides are equal and all the interior angles of the slit region are 90 degrees. Still alternatively, the slit region 5 can be cross-shaped as shown in FIG. 7A or may include a plurality of discrete regions as shown in FIG. 7B. It is to be noted that the slit region 5 is symmetrical with respect to the vertical center line 110 as well as the horizontal center line 111.

In any cases, minimum necessary rigidity and vibration damping effect can be obtained when the slit region 5 is such that the center of the region 5 is at the center of the color-selecting mask and 0.05≦X/W≦0.95 and 0.2≦Y/H≦1.

The mask according to the invention has been described with respect to an effective screen area having a slit region and a slot region surrounding the slit region.

FIGS. 7C-7F illustrate modifications to the slit region.

As shown in FIGS. 7C and 7E, the mask may be configured such that a mixture of slit structure and slot structure exists in a certain region surrounded by a slot region. For example, as shown in FIGS. 7D and 7E, groups of slits may be formed in an area corresponding to the slit region 5 at intervals equivalent to several pitches of long narrow elements, the area being surrounded by a slot region. This structure adds more rigidity to the area corresponding to the slit region 5 and prevents the slots from deforming.

As described above, the tensioned mask structure 1 according to the first embodiment has rigidity just like a real bridge type color-selecting mask and vibration damping property just like an aperture grille type color-selecting mask.

### Second Embodiment

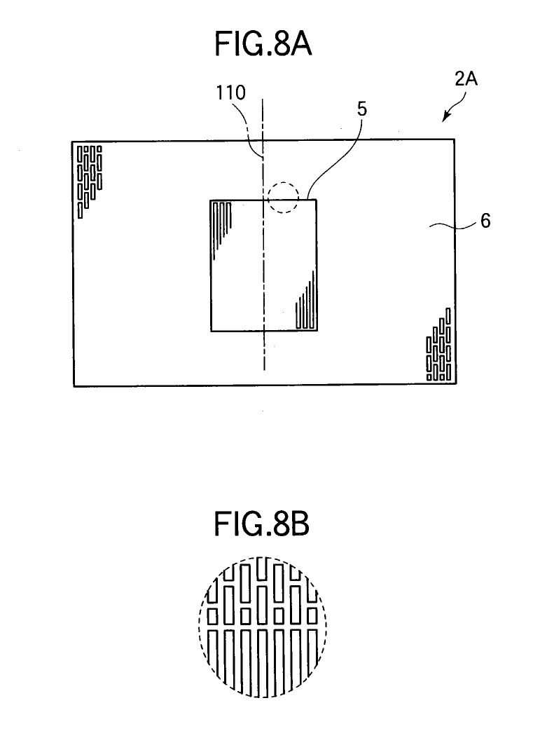

FIGS. 8A-8B illustrate the arrangement of real bridges formed in a tensioned mask structure for a color CRT according to a second embodiment. FIG. 8A is a general front view of an effective area 2A of the tensioned mask structure 2 and FIG. 8B is a partial enlarged view of an encircled boundary portion 110 of FIG. 8A.

In the second embodiment, some of the real bridges are arranged in a specific manner. The slit region according to the second embodiment is assumed to have slits or a mixture of slits and slots. As shown in FIG. 8A, the real bridges in a slot region 6 are aligned straight in directions in which the slits 5 in the slit region 5 extend.

The arrangement of the real bridges as described above will minimize the deformation of the slot region 6 and improve the image quality of the CRT.

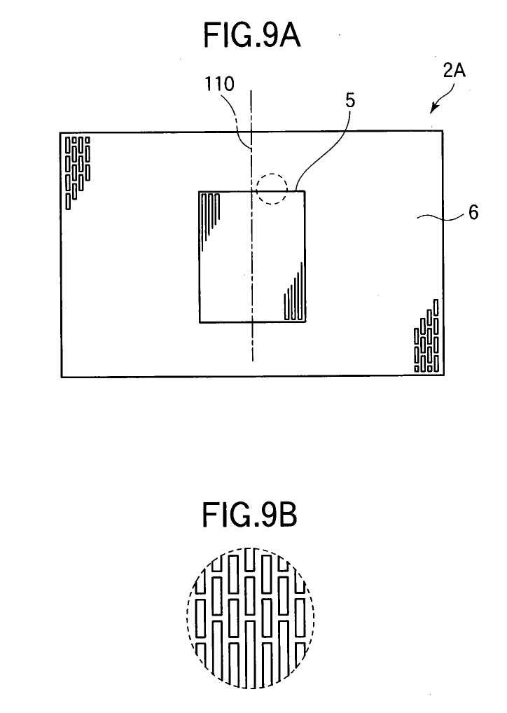

The operation and advantages of the effective mask area 2A in FIGS. 8A and 8B will be described. FIGS. 9A and 9B illustrates the arrangement of the real bridges formed in a tensioned mask structure that does not employ the configuration of the second embodiment. FIG. 9A is a general front view of the effective mask area and FIG. 9B is a partial enlarged view of an encircled boundary portion 110 of FIG. 9A.

As shown in FIG. 9A, the slit region 5 is substantially rectangular as a whole. The effective mask 2A area has a line of real bridges that draws a boundary between the slit region 5 and the slot region 6. The line of real bridges include even-numbered real bridges and odd-numbered real bridges, the even-numbered real bridges being spaced apart in a vertical direction of the screen from the odd-numbered real bridges.

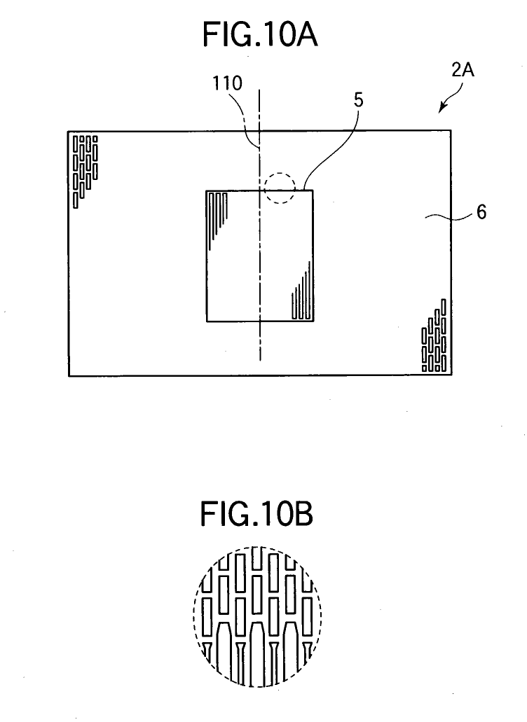

FIGS. 10A and 10B illustrate the slits when the color-selecting mask in FIG. 9A is mounted on the mask frame 3. FIG. 10A is a general view of the effective mask area 2A and FIG. 10B is a partial enlarged view of an encircled boundary portion between the slit region and the slot region in FIG. 10A. It is to be noted that the horizontal dimension of slits include a narrow slit and a wide slit appearing alternately after the color-selecting mask has been mounted on the mask frame 3.

This is due to the fact that slightly different lengths of adjacent slits create a difference in stress exerted on the portions near the slits when the color-selecting mask is mounted on the mask frame. This difference produces a force that causes the slits to deform in the horizontal direction of the screen. Deformation of the slits, if prominent, can be viewed as narrow lines in the images on the screen of the CRT. The tensioned mask structure 1 according to the second embodiment minimizes this problem.

FIGS. 10A and 10B illustrate another modification of the contour of the slit region. FIG. 10B is an expanded view of an encircled portion of a boundary between the slit region and the slot region.

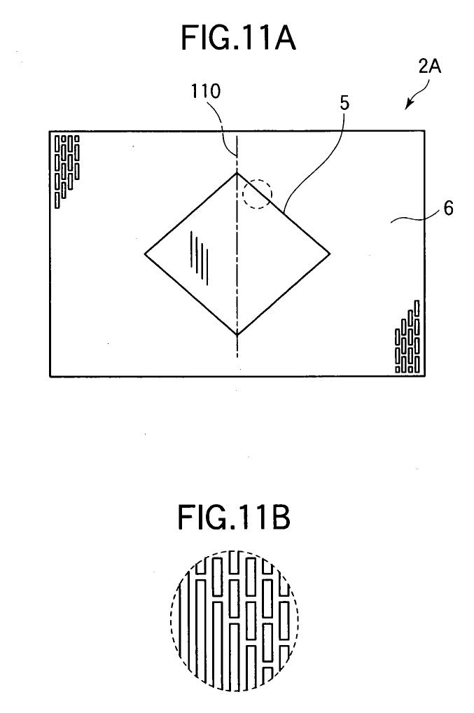

While the slit region 5 according to the second embodiment is substantially rectangular, the slit region 5 may be of other shapes, for example, a diamond in FIG. 11A. Referring to FIG. 11B, the real bridges at the boundary between the slit region 5 and the slot region 6 are positioned such that each real bridge is displaced ahead of a preceding one in the vertical direction of the screen. This structure minimizes the deformation of the slits.

In other words, the length of the slits in the slit region 5 at the boundary between the slit region 5 and the slot region 6 should be selected such that the slits in the slit region 5 are configured to the overall shape of the slit region 5.

### Third Embodiment

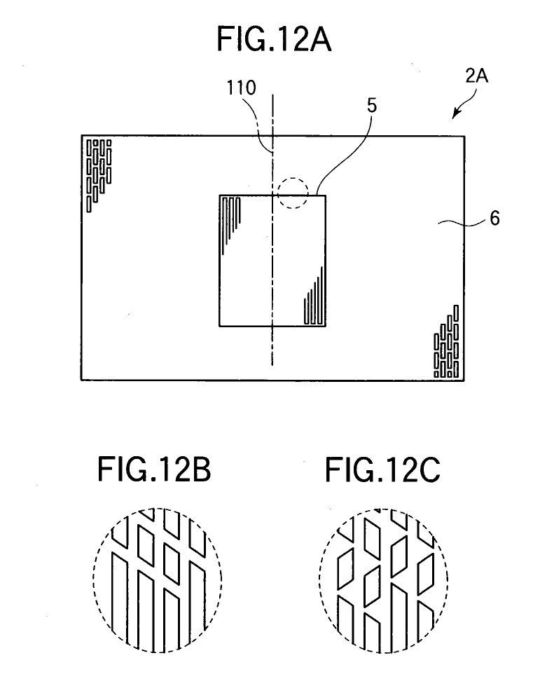

FIGS. 12A and 12B illustrate the shape of slots formed in a tensioned mask structure according to a third embodiment for a color CRT of the invention. FIG. 12A is a general view of the effective mask area 2A. FIG. 12B is a partial enlarged view of an encircled portion of FIG. 12A. FIG. 12C is a partial enlarged view of an encircled portion of FIG. 12A.

The tensioned mask structure has a specific shape of the slots in the slot region 6. Referring to FIG. 12B, the slot in the slot region 6 has a perimeter that extends at an angle with a vertical direction or a horizontal direction of the screen. The shape of the slot allows adjustment of stress exerted on a portion of the mask near the slits when the mask is mounted on the mask frame 3 (see FIG. 1). The third embodiment allows minimizing of the deformation of the slits just as in the second embodiment.

FIG. 12C is an enlarged view, illustrating a modification to the slot in FIG. 12B. The shape and location of the slots can be selected as required to minimize the deformation of slits.

### Fourth Embodiment

FIGS. 13A-13C illustrate a pertinent portion of a tensioned mask structure according to a fourth embodiment of a color CRT. FIG. 13A is a perspective view of the tensioned mask structure. FIGS. 13B and 13C are partial enlarged views of portions 104 and 105 of FIG. 13A, respectively.

The fourth embodiment differs from the first embodiment in the shape of electron beam passing holes formed in the color-selecting mask 12.

Referring to FIG. 13B, the slit region 5 has long narrow elements 8 that extend in a vertical direction of the screen and are aligned in a horizontal direction to define a narrow slit between adjacent long narrow elements 8.

As shown in FIG. 13C, the slot region 6 in the color-selecting mask 12 has bridges 7 and dummy bridges 16. The bridges 7 are formed at predetermined intervals between adjacent long narrow elements to define a line of slits that extends along the adjacent long narrow elements 8. The dummy bridges 16 are formed between adjacent bridges 7. Adjacent long narrow elements have projections, i.e., dummy bridges 16 that extend toward each other with a small gap between the projections, so that the slit has a constriction 16a therein. Each slit extends in a direction parallel to the line of slits and has the constriction 16 in the longitudinal middle of the slit.

The tensioned mask structure 11 according to the fourth embodiment is effective in minimizing moire fringes resulting from mutual interference between the real bridges and electron beam scanning lines. Selecting optimum pitches of the dummy bridge 16 in the vertical direction will minimize moire fringes.

### Fifth Embodiment

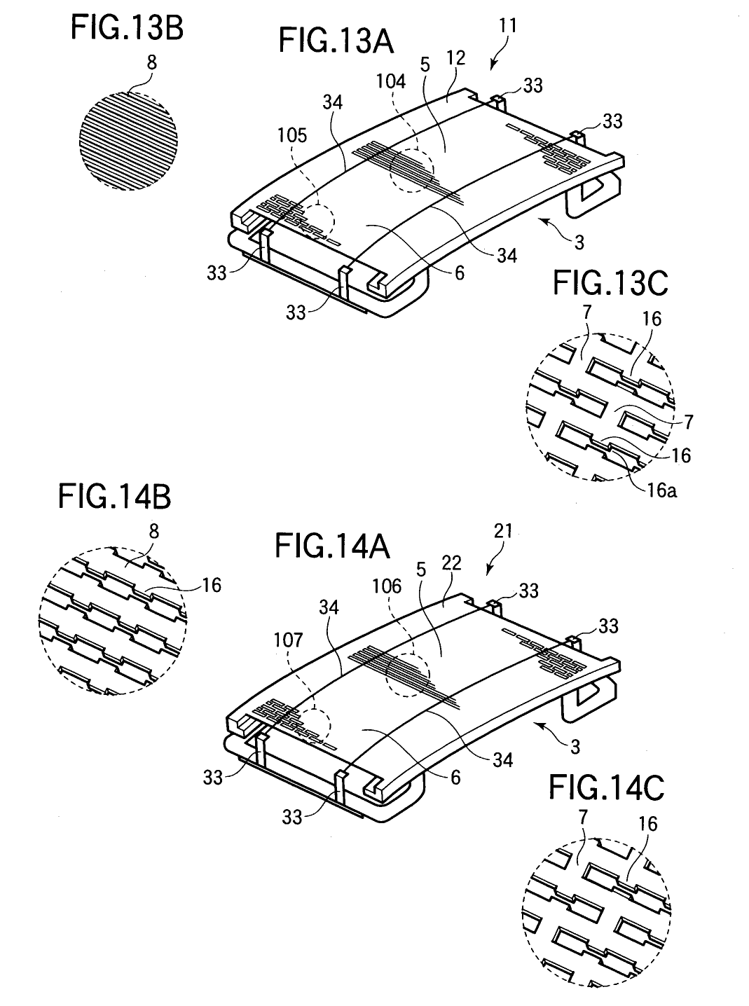

FIGS. 14A-14C illustrate a pertinent portion of a tensioned mask structure according to a fifth embodiment for a color CRT. FIG. 14A is a perspective view of the tensioned mask structure. FIGS. 14B and 14C are partial enlarged views of portions 106 and 107 of FIG. 14A, respectively.

The fifth embodiment differs from the first embodiment in the shape of electron beam passing holes formed in a color-selecting mask 22 of a tensioned mask structure 21.

The slit region 5 of the color-selecting mask 22 has long narrow elements 8 that extend in the vertical direction of the screen and aligned in the horizontal direction to define long slit between adjacent long narrow elements 8. Each slit has the constriction 16a at predetermined intervals. In other words, the color-selecting mask 22 is an aperture grille.

As shown in FIG. 14C, the slot region 6 has slots of the same shape as the slots according to the fourth embodiment.

The fifth embodiment provides uniform characteristics resulting from the presence of the dummy bridges 16 formed over the entire effective mask area of the color-selecting mask 22, so that the feeling of the entire image on the screen becomes uniform and the image quality of the CRT is improved accordingly.

The constrictions 16a of the fourth and fifth embodiments are defined between the dummy bridges 16 formed on the long narrow elements 8. The dummy bridges 16 are arranged in an N-by-N matrix form. That is, dummy bridges 16 are positioned at points where vertically extending lines cross horizontally extending lines.

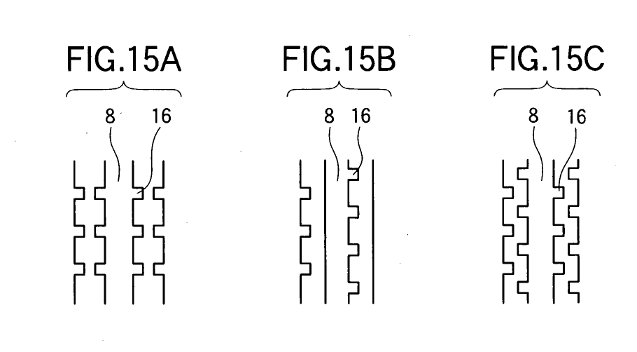

FIGS. 15A-15C illustrate modifications to the dummy bridges.

The dummy bridges 16 may be of variety of shapes. For example, as shown in FIG. 15A, each of the long narrow elements 8 has projections formed thereon simply at predetermined intervals. As shown in FIG. 15B, odd-numbered long narrow elements 8 and even-numbered long narrow elements 8 may have projections to form asymmetrical dummy bridges. still alternatively, as shown in FIG. 15C, each long narrow element 8 has first projections on its left side and second projections on its right side, each of the first projections being between adjacent second projections.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

What is claimed is:

1. A tensioned mask structure for a color CRT, the structure including a color-selecting mask that is formed with a plurality of electron beam passing holes therein, a mask frame on which the color-selecting mask is mounted, and a vibration-attenuating mechanism in contact with the color-selecting mask to damp vibration of the color-selecting mask, wherein an effective mask area of the color-selecting mask comprises:
a slit region having a plurality of long narrow elements that extend in a vertical direction of a screen of the CRT and are aligned to define slit-like holes between adjacent long narrow elements; and
a slot region having a plurality of slot-like holes shorter than the slit-like holes, the slot-like holes extending in the vertical direction;
wherein said slit region is formed in an area except a left peripheral portion and a right peripheral portion of the effective mask area.

2. The tensioned mask structure for a color CRT according to claim 1, wherein the slit-like holes are defined by forming bridges that connect adjacent long narrow elements at predetermined intervals, the bridges near a boundary between the slit region and the slot region being formed in accordance with a shape of slit region such that a substantially straight boundary is defined between the slit region and the slot region.

3. The tensioned mask structure for a color CRT according to claim 1, wherein the slit-like holes are defined by forming bridges that connect adjacent long narrow elements at predetermined intervals, the bridges adjacent to a boundary between the slit region and the slot region being formed in accordance with a shape of the slit region to define the boundary such that each of the bridges is displaced ahead of a preceding one in the vertical direction of the screen.

4. The tensioned mask structure for a color CRT according to claim 1, wherein the slit region is symmetrical with respect to a horizontal center line of the effective mask area and with respect to a vertical center line of the effective area.

5. The tensioned mask structure for a color CRT according to claim 1, wherein the vibration-attenuating mechanism includes:
at least two springs provided on the mask frame; and
at least one damper wire mounted in contact with the color-selecting mask between the two springs so that the damper wire is held taut across the effective mask area.

6. The tensioned mask structure for a color CRT according to claim 4, wherein the slit region has a horizontal length in the range of 5 to 95% of a full horizontal length of the effective mask area.

7. The tensioned mask structure for a color CRT according to claim 4, wherein the slit region has a vertical length in the range of 20 to 100% of a full vertical length of the effective mask area.

8. The tensioned mask structure for a color CRT according to claim 4, wherein the slot-like holes are defined by forming bridges that connect adjacent long narrow elements at predetermined intervals.

9. The tensioned mask structure for a color CRT according to claim 8, wherein each of the slot-like holes has opposing perimeters that extend substantially in the vertical direction and a perimeter at an angle with the horizontal direction.

10. The tensioned mask structure for a color CRT according to claim 8, wherein each of the slot-like holes has a constriction (16a) defined by projections (16) that project toward each other from adjacent long narrow elements.

11. A color CRT having a face panel, a funnel, and a neck which are formed in one piece construction, the color CRT incorporating a tensioned color-selecting mask according to claim 1.

12. A tensioned mask structure for a color CRT, the structure including a color selecting mask formed with a plurality of electron beam passing holes, a mask frame on which the color-selecting mask is mounted, and a vibration-attenuating mechanism in contact with the color-selecting mask to damp vibration of the color-selecting mask, wherein the color-selecting mask comprises an effective mask area that includes a slot region (6) having slot-like holes and a mixture region having slit-like holes and slot-like holes;
wherein the slit-like holes are defined between adjacent ones of a plurality of long narrow elements that extend in a vertical direction of a screen of the CRT; and
wherein the slot-like holes are shorter than the slit-like holes and extend in the vertical direction;
wherein the mixture region (5) is formed in an area except a left peripheral portion and a right peripheral portion of the effective mask area.

13. The tensioned mask structure for a color CRT according to claim 12, wherein the slit-like holes are defined by forming bridges that connect adjacent long narrow elements at predetermined intervals, the bridges being formed to define a substantially straight boundary between the mixture region and the slot region.

14. The tensioned mask structure for a color CRT according to claim 12, wherein the slit-like holes are defined by forming bridges that connect adjacent long narrow elements at predetermined intervals, the bridges adjacent to a boundary between the slit region and the slot region being formed in accordance with a shape of the slit region to define the boundary such that each of the bridges is displaced ahead of a preceding one in the vertical direction of the screen.

15. The tensioned mask structure for a color CRT according to claim 12, wherein the vibration-attenuating mechanism includes:
at least two springs provided on the mask frame; and
at least one damper wire mounted in contact with the color-selecting mask between the two springs so that the damper wire is held taut across the effective mask area.

16. A color CRT having a face panel, a funnel, and a neck which are formed in one piece construction, the color CRT incorporating a tensioned color-selecting mask according to claim 12.
